(19) United States
(12) Patent Application Publication
(10) Pub. No.: US 2005/0148379 A1
(43) Pub. Date: Jul. 7, 2005

(54) Method and apparatus for awarding prizes to players based on patterns in game results

(76) Inventors: Marcel Huard, St-Romuald (CA); Real Berube, St-Jean-Chrysostome (CA); Benoit Bedard, St-Romuald (CA)

Correspondence Address: OGILVY RENAULT LLP, 1981 MCGILL COLLEGE AVENUE, SUITE 1600, MONTREAL, QC, H3A2Y3, CA

(21) Appl. No.: 11/013,347

(22) Filed: Dec. 17, 2004

Related U.S. Application Data
(63) Continuation-in-part of application No. 10/409,475, filed on Apr. 9, 2003.
Application No. 10/409,475 is a continuation-in-part of application No. PCT/CA01/01468, filed on Oct. 22, 2001.
(63) Continuation-in-part of application No. 10/462,766, filed on Jun. 17, 2003.
(63) Continuation-in-part of application No. PCT/CA04/00892, filed on Jun. 16, 2004.
Application No. PCT/CA04/00892 is a continuation-in-part of application No. 10/462,766, filed on Jun. 17, 2003.
(60) Provisional application No. 60/241,740, filed on Oct. 20, 2000.
(60) Provisional application No. 60/296,486, filed on Jun. 8, 2001.
(60) Provisional application No. 60/296,453, filed on Jun. 8, 2001.

(51) Int. Cl. A63F 13/00

(52) U.S. Cl. 463/16

(57) ABSTRACT

A method for tracking game results obtained by a player in a plurality of instances of the game and awarding prizes to said player based on patterns detected in the game results is provided. The method comprises retrieving a set of at least one rule for the game and a set of at least one pattern to be tracked; choosing at least one alphanumerical character for each instance of said game; placing a wager that the chosen alphanumerical character will be generated during an instance of the game; generating at least one alphanumerical component according to said rule for each said instance; comparing each character with each component to obtain a set of matching elements for each instance of the game; storing the result of at least one of said choosing, said placing, said generating and said comparing for each instance of the game played by the player for the plurality of instances of the game; detecting at least one pattern of said set in the results stored for said plurality of instances; selecting a pattern prize to be awarded to said player based on said pattern detected.

### CROSS-REFERENCE TO RELATED APPLICATIONS

The application is a continuation-in-part of pending U.S. patent application Ser. No. 10/409,475 filed on Apr. 9, 2003 (Agent's reference no. 12296-15us) which is in turn a continuation-in-part of PCT patent application serial No. PCT/CA01/01468 filed on Oct. 22, 2001 (Agent's reference no. 12296-15pot) and which claimed priority of U.S. provisional patent applications Ser. Nos. 60/241,740 (Agent's reference no. 12296-15uspr-mbg), 60/296,486 (Agent's reference no. 12296-15uspr) and 60/296,453 (Agent's reference no. 12296-16uspr) respectively filed on Oct. 20, 2000, Jun. 8, 2001 and Jun. 8, 2001, all of which are incorporated herein by reference.

This application is also a continuation-in-part of pending U.S. patent application Ser. No. 10/462,766 filed on Jun. 17, 2003 (Agent's reference no. 12296-26us), which is incorporated herein by reference.

This application is further a continuation-in-part of pending PCT patent application serial number PCT/CA2004/000892 filed on Jun. 16, 2004 (Agent's reference no. 12296-26pct) which in turn claims priority and is a continuation-in-part of U.S. patent application Ser. No. 10/462,766 filed on Jun. 17, 2003 (Agent's reference no. 12296-26us), all of which are incorporated herein by reference.

### FIELD OF THE INVENTION

The invention relates to managing bets in a gaming environment. More specifically, it relates to collecting bets in advance for a plurality of games to be played and detecting patterns in the game results to award prizes to the player.

### BACKGROUND OF THE INVENTION

Keno is similar to Lotto but is typically played in a Casino. It was first introduced in China many years ago. The game was brought to the USA in the mid 1800's by the Chinese immigrants who came to work in the mines and on the railroad. It is a very popular game and very easy to play. It is an exciting pastime and, most importantly, it offers the possibility of winning large payouts on relatively small wagers.

Keno can usually be played in the keno lounge, in most dining areas, or at portable keno stations on the casino floor. If players wish to play keno outside of the lounge area, keno runners circulate the casino ready to place wagers, and numerous television monitors keep players informed of the winning numbers.

The keno numbers are printed on 80 individual ping-pong balls, which are either spun around in a wire bird cage, or blown around in a large clear plastic sphere. As each ball is selected, the winning number is electronically highlighted on the keno boards throughout the casino. Alternatively, the keno numbers are randomly drawn by an electronic device and then displayed on the keno boards. The house draws 20 numbers out of the field of 80.

Players can choose as few as one number or as many as 15. To place bets, a keno ticket, which has boxes for all 80 numbers must be filled out. In most Casinos winning bets must be collected before the next game begins. A player can win as little as one dollar to as much as 50,000 credits depending on how many numbers were selected and the amount wagered. A typical Keno payout table is as follows:

| Number of | Spots Selected | | | | | | | | | | | | | | |
|---|---|---|---|---|---|---|---|---|---|---|---|---|---|---|---|
| matches | 1 | 2 | 3 | 4 | 5 | 6 | 7 | 8 | 9 | 10 | 11 | 12 | 13 | 14 | 15 |
| 0 | 0 | 0 | 0 | 0 | 0 | 0 | 0 | 0 | 0 | 0 | 0 | 0 | 0 | 0 | 0 |
| 1 | 3 | 1 | 1 | 0.5 | 0.5 | 0.5 | 0.5 | 0.5 | 0.5 | 0 | 0 | 0 | 0 | 0 | 0 |
| 2 | — | 9 | 2 | 2 | 1 | 1 | 0.5 | 0.5 | 0.5 | 0.5 | 0.5 | 0 | 0 | 0 | 0 |
| 3 | — | — | 16 | 6 | 3 | 2 | 1 | 1 | 1 | 1 | 1 | 0.5 | 0.5 | 0.5 | 0.5 |
| 4 | — | — | — | 20 | 15 | 3 | 6 | 3 | 2 | 2 | 1 | 1 | 0.5 | 0.5 | 0.5 |
| 5 | — | — | — | — | 50 | 30 | 12 | 6 | 4 | 3 | 2 | 2 | 3 | 2 | 1 |
| 6 | — | — | — | — | — | 75 | 36 | 19 | 8 | 5 | 6 | 4 | 4 | 3 | 2 |
| 7 | — | — | — | — | — | — | 100 | 90 | 20 | 10 | 15 | 24 | 5 | 5 | 5 |
| 8 | — | — | — | — | — | — | — | 720 | 80 | 30 | 25 | 72 | 20 | 12 | 15 |
| 9 | — | — | — | — | — | — | — | — | 1200 | 600 | 180 | 250 | 80 | 50 | 50 |
| 10 | — | — | — | — | — | — | — | — | — | 1800 | 1000 | 500 | 240 | 150 | 150 |
| 11 | — | — | — | — | — | — | — | — | — | — | 3000 | 2000 | 500 | 500 | 300 |
| 12 | — | — | — | — | — | — | — | — | — | — | — | 4000 | 3000 | 1000 | 600 |
| 13 | — | — | — | — | — | — | — | — | — | — | — | — | 6000 | 2000 | 1200 |
| 14 | — | — | — | — | — | — | — | — | — | — | — | — | — | 7500 | 2500 |
| 15 | — | — | — | — | — | — | — | — | — | — | — | — | — | — | 10000 |

The first column indicates the number of catches or matches. This is cross-referenced to the number of spots selected that is indicated by the other fifteen columns. To use the table, look across the top for the number of 'spots' chosen, then follow that column down to the row where it crosses the number of matches made. The number at the intersection of the row and column is the payout ratio that will be received. In the table, the presence of a “-” indicates no pay out as does a “0”.

For example: 6 matches off eleven spots will pay out six times your initial bet. 2 matches off eleven spots will pay out half your initial bet. 5 matches off six spot will pay out thirty times your initial bet.

Payouts differ depending on where Keno is played as well as how many numbers the player originally picked and how many of those were caught. For example, on a 6-spot (meaning six numbers were marked) the player needs to catch three numbers to break even; on a 15-spot one usually needs six numbers to win any money.

Keno ticket variations exist to create more excitement and offer a little diversity. A short description of some tickets types follows : Straight Tickets: To play a straight ticket, the player needs to mark off the numbers he hopes to come up in the draw and mark the number of spots in the provided area. The maximum number of spots that can be marked off depends on the casino, but the limit doesn't typically exceed 20, as that is the number of balls drawn.

Way Tickets: Playing a way ticket means that the player uses one ticket to mark two or more sets of numbers. In fact, playing one 3-way ticket is the same as playing three 1-way tickets and marking the numbers on those individually. Both offer the same chances of winning, the same odds and, of course, the same payouts.

Combination Tickets: Playing a combination ticket means that the player is combining the groups that were previously treated separately on way tickets. Using the previous example, when the player plays a 3/3, he is betting on three sets of three numbers each. Adding to that, he can also bet on 3 ways of making a 6 or 3/6 (by combining two of the groups) or he could bet on 1 way of making a 9 or 1/9 (by combining all three groups). However, he does not have to bet on every possible combination.

Aside from using the above-mentioned ways to play keno, you can also simply divide up the ticket in several ways. Top or Bottom: When playing a top or bottom ticket, the player simply marks off which of the two areas he wishes to bet on. If 13 of the 20 numbers drawn fall on the chosen half, the player wins.

Left or Right: The same concept applies to this ticket as to the “top or bottom”. In this case, the player is selecting either the left or the right half of the ticket. Again, 13 numbers must fall on the side chosen to win.

Edges: When one chooses to play the edges, all the edges are marked. The Casino decides how many numbers are needed to catch in order to win.

Typically a player is allowed to buy a large number of tickets using the same numbers. Usually this number is limited to twenty games. After this ‘multi race’ ticket has lasted the 20 (or however many are chosen) games, the player can go to a keno clerk and have them check for winning games.

A third option exists for people who really do not want to pay attention to the numbers being drawn. At many casinos you can buy a ‘stray and play’ keno ticket which applies to the next ‘X’ number of games (‘X’ is usually greater than 20, or whatever the maximum ‘multi-race’ game number is). The difference being that it is not necessary to validate the ticket after the 25 or 30 games have run through. The player can come back any time. Most stray and play tickets are good for up to a year. This means that the player can buy a ticket for the ‘next’ 60 games, and if the ticket happens to match all the numbers without even realizing it on the 36th game, the player can leave the country and come back to the casino eight months later, walk to the keno clerk, have them check the ticket, and pick up the winnings.

Roulette was first played in France back in the 17th century. Players, usually up to eight, play against the house represented by the croupier also called the dealer, who spins the roulette wheel and handles the wagers and payouts. The wheel has 37 slots representing 36 numbers and one zero. In the USA most roulette wheels have two zeros and therefore 38 slots.

To play roulette, the player places his bet or bets on numbers (any number including the zero) in the table layout or on the outside, and when everybody at the table has had a chance to place their bets, the croupier starts the spin and launches the ball. Just a few moments before the ball is about to drop over the slots, the croupier says ‘no more bets’. From that moment no one is allowed to place—or change—their bets until the ball drops on a slot. Only after the croupier places the dolly on the winning number on the roulette table and clears all the losing bets, can the players then start placing their new bets while the croupier pays the winners. The winners are those whose bets match the number identified by the dolly.

There are two betting categories: inside bets and outside bets. The different inside bets are: Single Number Bet (Straight Bet, Double Zero, Zero), Split Bet, Square Bet, Street Bet, Line Bet, Special Line Bet: Betting on the first line of five numbers on the layout [00, 0, 1, 2 and 3]. The bet is done by putting the chip on the line at the end of the layout between the first line and the zero line that you wish to bet on. The different outside bets are: Dozens bet, Column bet, Odd or Even, Red or Black, High or Low.

The ‘En Prison’ rule is a roulette rule applied to even-money bets only, and by some casinos (not all). When the outcome is zero, some casinos will allow the player to either take back half his/her bet or leave the bet (en prison=in prison) for another roulette spin. In the second case, if the following spin the outcome is again zero, then the whole bet is lost. The ‘La Partage’ rule is similar to the en prison rule, only in this case the player loses half the bet and does not have the option of leaving the bet en prison for another spin. This refers to the ‘outside’ even-money bets Red/Black, High/Low, Odd/Even and applies when the outcome is zero. Both the La Partage and the En Prison roulette rules essentially cut the casino edge on the ‘even-money bets’ in half.

The payouts are typically as follows:
A bet on one number only, called a straight-up bet, pays 35 to 1. (You collect 36).
With no house advantage you should collect 37 (38 in the USA on double zero roulette wheels).
A two-number bet, called split bet, pays 17 to 1.
A three-number bet, called street bet, pays 11 to 1.
A four-number bet, called corner bet, pays 8 to 1.
A six-number bet, pays 5 to 1.
A bet on the outside dozen or column, pays 2 to 1.
A bet on the outside even money bets, pays 1 to 1.

All betting strategies for Keno, Roulette and other lotteries take into account a bet for an instance of the game. All bets are reset after each game is ended and a new betting period begins. In Keno, if the player purchased a multi race or a stray and play ticket, the bet is repeated for the next game and the next game starts. In Roulette, with the “En Prison” rule, the bet is repeated for the next game. There is no continuing relationship between each game being played and the player does not have more incentive to play many times over a period of time or play repeatedly at each game for a series of games.

### SUMMARY OF THE INVENTION

Accordingly, an object of the present invention is to provide the player with a further incentive to play a game by creating a memory of consecutive games played for the player.

This memory stores the results of each game played by the player over a period of time or a number of instances of a game and a pattern detector detects patterns in the winnings of the player. Once patterns are detected, a prize can be awarded to the player.

According to a first broad aspect of the present invention, there is provided a method for tracking game results obtained by a player in a plurality of instances of the game and awarding prizes to said player based on patterns detected in the game results is provided. The method comprises retrieving a set of at least one rule for the game and a set of at least one pattern to be tracked; choosing at least one alphanumerical character for each instance of said game; placing a wager that the chosen alphanumerical character will be generated during an instance of the game; generating at least one alphanumerical component according to said rule for each said instance; comparing each character with each component to obtain a set of matching elements for each instance of the game; storing the result of at least one of said choosing, said placing, said generating and said comparing for each instance of the game played by the player for the plurality of instances of the game; detecting at least one pattern of said set in the results stored for said plurality of instances; selecting a pattern prize to be awarded to said player based on said pattern detected.

According to a second broad aspect of the present invention, an apparatus for tracking game results obtained by a player in a plurality of instances of the game and awarding prizes to said player based on patterns detected in the game results is provided. The system comprises a rule provider for retrieving a set of at least one rule for the game; a pattern provider for retrieving a set of at least one pattern to be tracked; a bet provider for choosing at least one alphanumerical character for each instance of said game and placing a wager that the chosen alphanumerical character will be generated during an instance of the game; a game outcome generator for generating at least one alphanumerical component according to said rule for each said instance; a game result determiner for comparing each character with each component to obtain a set of matching elements for each instance of the game; a bet memory receiving information from at least one of said bet provider, said game outcome generator, said game result determiner for each instance of the game played by the player for the plurality of instances of the game; a pattern extractor for detecting at least one pattern of said set in the results stored for said plurality of instances; a pattern prize selector for selecting a pattern prize to be awarded to said player based on said pattern detected.

In the present disclosure, the term “alphanumerical characters” is intended to mean a chain of numbers, a chain of letters or a chain of characters having at least one number and at least one letter.

### BRIEF DESCRIPTION OF THE DRAWINGS

These and other features, aspects and advantages of the present invention will become better understood with regard to the following description and accompanying drawings wherein:

FIG. 1 is a block diagram of the main components of the preferred embodiment;

FIG. 2 is a flow chart of the main steps of the preferred embodiment;

### DETAILED DESCRIPTION OF THE PREFERRED EMBODIMENT

The present invention can be used with a plurality of games, such as Keno, Lottery, Roulette, etc. It is versatile enough to be combined with almost any type of game known in the art and is interesting to players sufficiently to be played on its own.

The present invention is for a system for tracking game results and awarding prizes based on patterns detected in the game results. It comprises a memory which stores the results of each game played by the player over a period of time or over a number of instances of a game and a pattern detector which detects patterns in the winnings of the player. Once patterns are detected, a prize selector selects a prize (additional to that which can be awarded for winning each specific instance of the game according to the game rules) which can be awarded to the player.

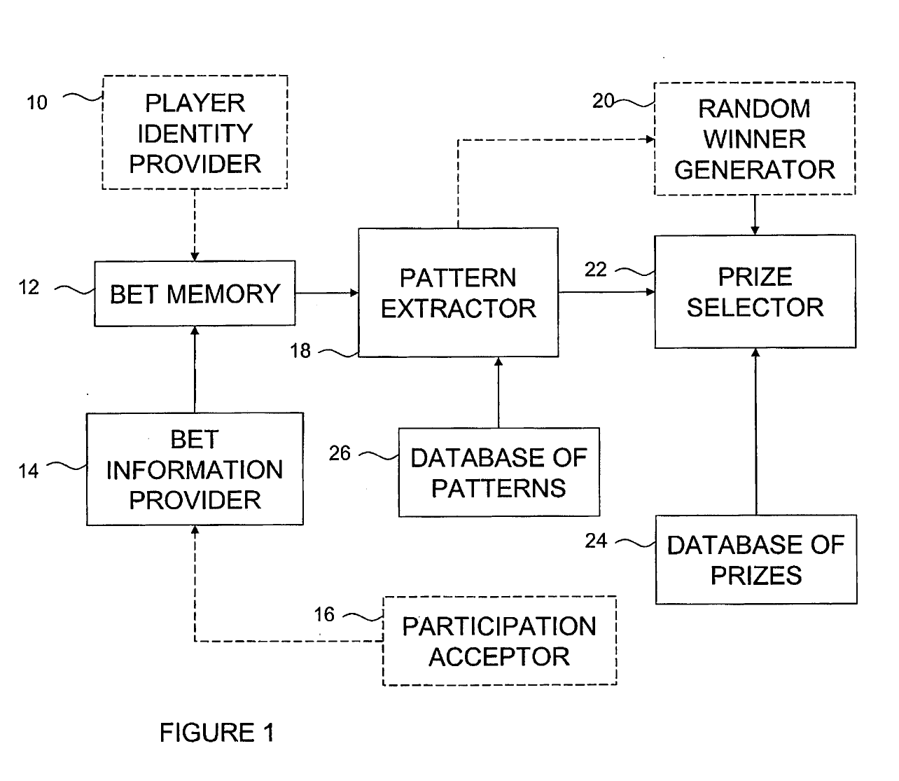

The preferred embodiment of the present invention comprises the following components which will be detailed in reference to FIG. 1. A bet memory 12 receives information concerning the bet from a bet information provider 14. The bet memory 12 can be provided on a portable smart card which can receive an upload of information and which permits a download of information. This smart card should be uniquely matched with a player and carried around for participation in the games. This smart card can be read by a plurality of card readers, preferably connected to a game controller, directly, or through a network such as the internet A player profile is kept on the game controller to update the bet memory of the player's smart card. The bet information provider 14 which can also be provided partly on the smart card and partly in the game controller allows to get information concerning the bet placed by the player. The smart card can be inserted in a card reader at the time of placing the bet and the information concerning the bet can be downloaded on the card. Alternatively, the player's profile is fully stored in the game controller and all information about the bets and the player are updated in the game controller through dealer or clerk updates via consoles.

A pattern extractor 18 receives the data stored in the bet memory 12 and identifies the presence of patterns by comparing the contents of the bet memory 12 with elements of patterns stored in a database of patterns 26. The patterns are typically programmed in the game controller by the Casino management. The information concerning the bet is retrieved and compared with the stored pattern by a simple comparison procedure provided in a software component of the game controller.

If a pattern is detected, it triggers a prize selector 22 to select a prize for the winner from a database of prizes 24. A database of prizes 24 is kept by the Casino Management and the prize selector can use any predetermined rule for the attribution of a prize depending or not on the pattern identified.

The following components are optional but preferred: A player identity provider 10 retrieves information concerning the identity of the player and sends same to the pattern extractor 18 for comparison of the details of the identity of the player with the patterns in the database 26. The player identity provider obtains the information about the player from a special portion of memory of the smart card or the player's profile or from a biometrics reader or by biometrics recognition.

It should be noted that if the game is to be played over the Internet, the game controller will be located on a server managed by the Casino and the player profile can be resident either on the player's computer or on a server accessible by the game controller. A login and password will preferably be used to identify the player currently logging in and to retrieve the proper player profile. In some cases, where only one player resides

A participation acceptor 16 serves as a confirmation that the player wishes to participate in the present invention, either by sending a simple signal, upon receipt of a confirmation from the player, to the bet information provider 14 which enables the collection of information about the bet or by accepting a wager for participation in the invention, thereby confirming the player's wish to participate. It can be a coin acceptor, a link to an electronic bank, a points bank, a simple “I agree” button to be pressed or clicked, etc.

A random winner generator 20 can be used to randomly or semi-randomly determining if the player for which a pattern was identified will be awarded a prize.

In an embodiment of this invention combined with the game of Keno, the method would take place as follows: a player chooses at least one number from a pool of available numbers. For example, the numbers “1, 3, 8, 15, 37” are selected from the pool of available numbers from 1 to 80 (one could have chosen anywhere from, for example, 1 to 15 numbers). The player can also decide to be randomly attributed a combination of numbers. In that case, the player decides the quantity of numbers he wishes to get and a random number generator generates a combination.

By paying an appropriate betting amount for a series of instances of the game in advance, for example 4 games, the players can bet on the same combination of numbers for the whole series or choose different numbers for each game, as per the rules of the Casino or their own choice. In each game of the series, the chosen numbers are compared with the winning numbers. The winnings are resolved, for example, as per the traditional Keno game. However, in addition to the traditional resolving of winnings, the present invention provides for a memory of the outcome of each game of the series to store the game result. This memory stores the results of each game played by the player in the series and a pattern detector detects consecutive winnings or patterns in the winnings of the player.

In the example where 4 games are paid for in the series for a player, the pattern detected can be that the player has won at least the minimum amount in 2 of the 4 games of the series. This would yield a small additional prize. In the event that the player would have won the maximum amount in 3 of the 4 games of the series, for example with a complete match of all of his 5 numbers in 3 of the 4 games, a greater additional prize could be awarded.

The patterns that can be detected are numerous and are only limited by the Casino management staffs imagination. A non-exhaustive list of parameters which can be stored in memory for the detection of patterns is as follows: number of games won, number of games played, amount wagered, amount won, type of win (for example, 3 numbers matched out of 5, perfect match, etc.), physical location of player when he placed the bet (online, in a Casino (at which machine or table), at a video poker machine, etc.), type of purchase for ticket (automated, with clerk, etc.), player type (preferred, new, regular, etc.), time of purchase of ticket, etc. Examples of patterns to be detected are as follows. As will be noted, parameters can be combined to create complex patterns to be detected:
75% of games bet upon in a series are won by the player;
3 wins of at least the minimum amount in a row (consecutive);
client is a preferred player, client placed the bet through his online account, player placed the bet for 20 games in a series, client won at least 5 times in a row, each win being at least a 75% match win;
player purchased his ticket with a clerk in a Casino, client is a new player, player won with 2 numbers out of 20;
etc.

Once a predetermined pattern is recognized, a prize can be awarded to the player. In some embodiments, as soon as a pattern is detected, a prize is awarded to the player, the prize depending or not on the parameters of the pattern. As a general rule, the more complex the pattern or the less probability to achieve the pattern, the greater the prize. In some other embodiments, as soon as a pattern is detected, a small prize is awarded, always the same, for example a free participation in a game. In other embodiments, having achieved a detected pattern only gives the player a chance to win a prize. In these embodiments, a random prize generator or an amount directly proportional to the probability of obtaining the match can be used to determine whether this player receives a prize, and if so, what prize will be attributed to the player. The probability that the player will be attributed a prize by the random prize generator can also be affected by the parameters of the pattern. For example, if the pattern only requires that one parameter be present in the game results and the probability of the appearance of that parameter is quite high, the player will be awarded one chance to win the prize. If the pattern requires a plurality of parameters to be present and the probability of appearance of the pattern in the game results is quite low, the player who achieves the pattern will be given, for example, 100 chances to win the prize. Therefore, even though the prize may be accessible to all players who achieved a pattern to be detected, those who achieved the less probable pattern will have more chances of winning the prize.

The prize can be any type of incentive for the player. It can be a free turn for another play of the game, it can be an amount of credits or money, it can be a chance to participate in a jackpot draw, it can be a quantity of points to collect in order to use at a later time to obtain merchandise, services or participations in other games or lotteries, such as tournaments or VIP games. In that sense, the participation in the present method can be partially or totally free for the players. Indeed, if the first participation is given out for free as a way to interest players in the game and the player receives a free participation or an amount of points to be collected and/or used to participate again in the game, the player may not have to spend a single credit or cent to keep playing the present invention. The player may need to place a wager to participate in the present invention or is participation may be free, depending on the Casino management's intent.

Also, participation in the present invention may require a contribution by the player. The player may decide to place a separate wager for this aspect or may decide to spend credits from his electronic bank to play this additional game.

The winning numbers can be drawn from a container of balls as is typical with Keno games, determined by the number of the horse which wins a race or of the three horses that finish the race first in a live or electronic horse race, generated by a random number generator, determined by the location of the fall of the ball in a Roulette game, generated by the application of the laws of physics, etc. The winning numbers can also be obtained by a draw of geographical positions.

If the numbers are to be obtained from the game of Roulette, the game of Roulette is played as usual but the results for each instance of the game of Roulette are stored. In this embodiment, the player could even record his wager for the present method for a number of instances of the Roulette game and leave the Roulette table. He could even participate remotely. His regular Roulette earnings would be calculated by the dealer, preferably using a dealer console and a game controller and his earnings with the present invention would also be determined and stored for later collection of this prizes.

If the winning number corresponds to a geographical position, a numbering of positions should be used. For example, in a Casino chain of 5 casinos, each casino is assigned a number (from 1 to 5), each table within the casino is assigned a number (from 001 to 200), each player position (including or not the dealer position) is assigned a number (from 01 to 09) and each spectator position is assigned a number (from 10 to 28). The juxtaposition of each position locator could yield a complete number as follows: casino-table-position. For example, a player could be sitting at position 218803 which would mean that he is in Casino #2, at table #188 and at position #3 around the table.

Casino employees could form a special type of player who can participate in the present invention on their own time. They could have access to different payout tables and participation in this invention could be free for them as a reward for their work for the Casino. Also, when at work, the dealers are a category of players on which other players can placed bets in addition to placing bet on themselves or other people. Since some dealers may be more experienced at playing any specific game and since the rules by which the dealers play the games are more explicit and defined, the payouts for having won on a bet on a Casino employee may differ from that of a bet on another player.

Another way to identify a physical location for the draw would be the following nomenclature: galaxy name or number, constellation name or number, star name or number, asteroid name or number, planet name or number (the names being programmable), continent name or number; country name or number; state name or number; city name or number (the state and city numbers can be replaced by the zip code); spot name or casino name; group number, table number or section number (for example: 1 to 20); player position letter: A to H (in some cases, only A to E or A to G, depending on the type of game table); dealer position letter or number; spectator position letter or number; player ID number.

A sequence of letters and/or numbers would be used for at least one of these components to form a sequence of alphanumerical characters. The rule as to whether numbers or letters (and abbreviations or special codes) should be used would be predetermined and the player would have to respect them in the choice of this sequence. A random alphanumerical component would be generated by a random generator according to the rules. Each meaningful part of the sequence chosen by the player would be compared with the randomly generated sequence. The matches would result in wins.

Therefore, the prizes could be awarded as follows depending on how many parameters of the bet were a match with the pattern to be detected:
If there is a match for the spot name, the player wins a free game or 1× wager;
If there is a match for the group number, the player wins a free game or 1× wager;
If there is a match for the position letter, the player wins 2× the wager;
If there is a match for the player number, the player wins 25× the wager;
If there is a match for the spot and the position, the player wins 4× the wager;
If there is a match for the spot and the player, the player wins 4× the wager;
If there is a match for the spot and the group and the position, the player wins 100× the wager;
If there is a match for the spot and the group and the player, the player wins 2000× the wager;
If there is a match for the spot and the group and the position and the player, the player wins the amount accumulated in the jackpot or a portion thereof.

The jackpot may only be accessible to be won if the player placed more than one credit in the wager. For example, if the player played one credit, he would only get 25% of the jackpot, if he played 2 credits : 60% of the jackpot, 3 credits: 100% of the jackpot.

Alternatively, the geographical position of the player could be used, for example, the GPS coordinates or the latitude, longitude coordinates.

It is important to note that the geographical location and generated component or numbers against which the player's choice will be compared can be composed of only numbers, only letters, or a combination of both.

The pattern identified within a series of games played by the player could be compared with the patterns of other players participating in the same series of games. The player with the best sequence of wins or the least probable pattern within the series would win an auxiliary prize.

Information concerning the game, such as the winning numbers used, the random draw of the winning numbers, the identification of the winner, the value of the prize won, etc can be displayed on media devices. Information concerning the identity of the player may be obtained at the time of purchase of the ticket by the clerk or machine or can be detected automatically using an identity card or biometrics. Then, the identity of the winner of the present invention can be broadcasted rapidly and globally as soon as the winner is identified.

This game can be played on live table games, in electronic games, in electro-mechanical games such as Roulette, together with online games, etc. It can be completely embodied in a software or provided in part by mechanical means.

This game can be played remotely, for example, through the Internet, and participation in the game can be provided through clerks or automated validation machines.

The Casino defines the rules within which the game is to be played and the player determines how much he wishes to bet on this game, how many games he wishes to play and on which numbers he wishes to bet. The player feels responsible for the outcome of the game since a plurality of choices are offered to him in this game. The fact that he plays a plurality of consecutive games or a plurality of games within a predetermined period of time, or number of instances of the game is taken into account by the system and may entice the player into playing more games.

In traditional Keno, the same symbol cannot be drawn in two consecutive draws within a game since the symbol or number is removed from the available pool of numbers. In the present game, the same favorite numbers can be bet repeatedly if the player so wishes.

The game can also provide for a total quantity of winning numbers selected for a plurality of games to be matched with a set of numbers chosen by the player. For example, if the numbers “2, 3, 5, 6, 8, 10, 35” are chosen by the players and are bet in 10 consecutive games where 10 winning numbers are chosen in each game, for a maximum of 100 winning numbers, some of which can be drawn more than once, the player can be awarded an additional prize if all 7 numbers are drawn at some point during the 10 consecutive games.

Additionally, it is possible to take into account the order in which the winning numbers are selected and to let the player identify a sequence for his chosen numbers. Indeed, if a horse race is played, the sequence of apparition of the chosen numbers is important and the player could be compensated for having identified the first 3 horses and, additionally, for having identified the correct order in which the horses finished the race.

If the present invention is used in combination with the traditional game of Roulette, the following sequence of events could occur: The player places a wager for 10 games of Roulette in which only one winning number is chosen. He picks his 10 numbers. The game of Roulette is played 10 times and the winning numbers are compared to the numbers identified by the player. The pattern detected is a simple match of the numbers without a care for the order. The greater the number of matches, the greater the prize that can be awarded. In another version of the game, the order of appearance of the numbers forms part of the pattern and the match is only detected if the order is also correct.

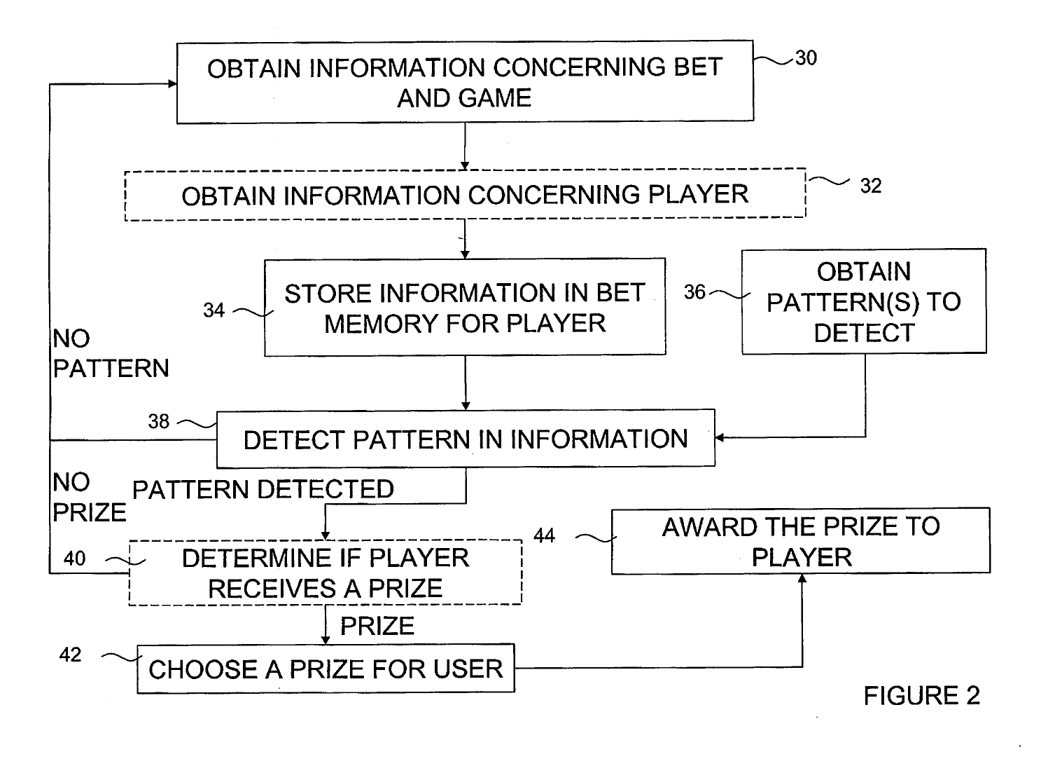

The main steps of the preferred embodiment will now be summarized with reference to FIG. 2. Information concerning the bet is obtained 30. Information concerning the player is optionally obtained 32. The information is stored in the bet memory for the player 34. A comparison of the information stored with patterns is made 38. If a pattern is detected, a determination as to whether the player receives a prize is done 40. A prize is chosen 42 and awarded to the player 44. If no pattern is detected or if no prize is to be awarded, the system is ready for the next game.

While illustrated in the block diagrams as groups of discrete components communicating with each other via distinct data signal connections, it will be understood by those skilled in the art that the preferred embodiments are provided by a combination of hardware and software components, with some components being implemented by a given function or operation of a hardware or software system, and many of the data paths illustrated being implemented by data communication within a computer application or operating system. The structure illustrated is thus provided for efficiency of teaching the present preferred embodiment.

It should be noted that the present invention can be carried out as a method, can be embodied in a system, a computer readable medium or an electrical or electromagnetic signal.

It will be understood that numerous modifications thereto will appear to those skilled in the art. Accordingly, the above description and accompanying drawings should be taken as illustrative of the invention and not in a limiting sense. It will further be understood that it is intended to cover any variations, uses, or adaptations of the invention following, in general, the principles of the invention and including such departures from the present disclosure as come within known or customary practice within the art to which the invention pertains and as may be applied to the essential features herein before set forth, and as follows in the scope of the appended claims.

1. A method for tracking game results obtained by a player in a plurality of instances of the game and awarding prizes to said player based on patterns detected in the game results, comprising:
retrieving a set of at least one rule for the game and a set of at least one pattern to be tracked;
choosing at least one alphanumerical character for each instance of said game;
placing a wager that the chosen alphanumerical character will be generated during an instance of the game;
generating at least one alphanumerical component according to said rule for each said instance;
comparing each character with each component to obtain a set of matching elements for each instance of the game;
storing the result of at least one of said choosing, said placing, said generating and said comparing for each instance of the game played by the player for the plurality of instances of the game;
detecting at least one pattern of said set in the results stored for said plurality of instances;
selecting a pattern prize to be awarded to said player based on said pattern detected.

2. A method as claimed in claim 1, further comprising determining, for each said instance, if a game prize should be awarded to said player for said set of matching elements according to said rule and if so, awarding said prize.

3. A method as claimed in claim 1, wherein said at least one alphanumerical character is a group of alphanumerical characters having a plurality of parts separately meaningful in said game.

4. A method as claimed in claim 3, wherein at least two of said parts of said alphanumerical characters are identical.

5. A method as claimed in claim 1, wherein said choosing comprising choosing a same at least one alphanumerical character for all instances of said game.

6. A method as claimed in claim 1, wherein said game is a game of Roulette, wherein said alphanumerical characters and components are Roulette numbers and wherein only one component is generated for each instance of the game.

7. A method as claimed in claim 1, wherein said game is a game of Keno and wherein said alphanumerical characters and components are Keno numbers.

8. A method as claimed in claim 1, further comprising paying for participating in said detecting.

9. A method as claimed in claim 1, wherein said pattern comprises a number of instances of said game to be tracked for said player, and wherein said method further comprises counting said instances of said game played by said player and after said number is reached, resetting said result stored.

10. A method as claimed in claim 3, further comprising specifying an order for said parts of said alphanumerical characters and components and wherein said comparing further comprises comparing an order of said characters and components to determine exact matches having a match of content and a match of order of said characters and components.

11. A method as claimed in claim 1, wherein said pattern prize is at least one of no prize, a free participation in said method, an access to a tournament game, a number of credits to be awarded to said player, a chance to win a jackpot prize and a number of points to be accumulated in a points account for said player.

12. A method as claimed in claim 1, wherein said alphanumerical character represents a physical location on which a bet is placed.

13. A system for tracking game results obtained by a player in a plurality of instances of the game and awarding prizes to said player based on patterns detected in the game results, comprising:
a rule provider for retrieving a set of at least one rule for the game;
a pattern provider for retrieving a set of at least one pattern to be tracked;
a bet provider for choosing at least one alphanumerical character for each instance of said game and placing a wager that the chosen alphanumerical character will be generated during an instance of the game;
a game outcome generator for generating at least one alphanumerical component according to said rule for each said instance;
a game result determiner for comparing each character with each component to obtain a set of matching elements for each instance of the game;
a bet memory receiving information from at least one of said bet provider, said game outcome generator, said game result determiner for each instance of the game played by the player for the plurality of instances of the game;
a pattern extractor for detecting at least one pattern of said set in the results stored for said plurality of instances;
a pattern prize selector for selecting a pattern prize to be awarded to said player based on said pattern detected.

14. A system as claimed in claim 13, further comprising a game prize selector for determining, for each said instance, if a game prize should be awarded to said player for said set of matching elements according to said rule and if so, awarding said prize.

15. A system as claimed in claim 13, wherein said at least one alphanumerical character is a group of alphanumerical characters having a plurality of parts separately meaningful in said game.

16. A system as claimed in claim 13, further comprising a payment acceptor for receiving a payment to participating in said detecting.

17. A system as claimed in claim 13, wherein said pattern comprises a number of instances of said game to be tracked for said player, and wherein said system further comprises a counter for counting said instances of said game played by said player and after said number is reached, resetting said result stored.

18. A system as claimed in claim 15, wherein said bet provider specifies an order for said parts of said alphanumerical characters and components and wherein said system further comprises an order comparator for comparing an order of said characters and components to determine exact matches having a match of content and a match of order of said characters and components.

19. A system as claimed in claim 13, wherein said alphanumerical character represents a physical location on which a bet is placed.
